(19) United States
(12) Patent Application Publication
(10) Pub. No.: US 2005/0146024 A1
(43) Pub. Date: Jul. 7, 2005

(54) Electronics unit

(75) Inventor: Bernd Thyzel, Schlossborn (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/023,932

(22) Filed: Dec. 28, 2004

(30) Foreign Application Priority Data
Dec. 29, 2003 (DE) 103 61 394.3

(51) Int. Cl. H01F 7/06

(52) U.S. Cl. 257/712

(57) ABSTRACT

An electronics unit includes a support in the form of a plate of an aluminum alloy. A ceramic substrate is adhesively attached to the substrate. A system of conductor tracks on which electronic power components are arranged is applied to the ceramic substrate. A film of an aluminum-silicon alloy is arranged between the support and the ceramic substrate and is chemically bonded to the support and the ceramic substrate in a thermal process.

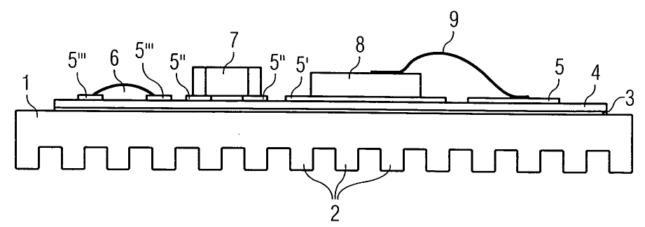

### BACKGROUND OF THE INVENTION

1. Field of the Invention

The invention relates to an electronics unit with a support in the form of a plate of aluminum or an aluminum alloy, on which there is adhesively attached a ceramic substrate, which is provided with a system of conductor tracks on which electronic power components are arranged.

2. Description of the Related Art

Electronics units used in automobile electronics have to withstand high ambient temperatures and adequately dissipate the lost heat of the electronic power components. In electronics units having support plates with an adhesively attached ceramic substrate, heat-conducting adhesives are used for the adhesive bonding of the ceramic substrate to the support.

The power density and power losses of the electronic power components in electronics units have increased such that the thermal conductivity of known heat-conducting adhesives is no longer adequate to pass on the heat generated by the electronic power components adequately to the support for heat dissipation. This leads to overloading of the electronic power components and consequently to high failure rates.

To avoid this, a number of power components are connected in parallel or structurally complex cooling measures are taken.

### SUMMARY OF THE INVENTION

An object of the invention is to provide an electronics unit with a support and a ceramic substrate which has a simple construction, can be easily produced and permits very good dissipation of the lost heat generated by the electronic power components.

This object is achieved according to the invention by arranging a film of an aluminum-silicon alloy between the support and the ceramic substrate and chemically bonding the film to the support and the ceramic substrate in a thermal process.

The thermal process, preferably under an inert gas atmosphere, produces a chemical bond between the two parts to be joined that is mechanically stable and has very good heat conduction. This good heat conduction of the film between the substrate and the support halves the thermal resistance in comparison with the known construction and considerably increases the service life of the electronic power components. This feature allows smaller, and consequently lower-cost, power components to be used, and/or reduces the number of components that is required to be used, which leads to a more compact construction of the electronics unit.

The film may have a thickness of approximately 5 μm to 70 μm, in particular between 10 μm and 50 μm.

This allows good compensation for tolerances of the ceramic substrate and the support.

For good heat dissipation, the support has a thickness which corresponds to a multiple of the thickness of the ceramic substrate, the support preferably having a thickness of approximately ten times the thickness of the ceramic substrate.

For further improvement of the heat dissipation, the support may have cooling ribs on its side facing away from the ceramic substrate.

A good heat transfer from the electronic power components to the support is achieved by a ceramic substrate that is as thin as possible, the ceramic substrate having a thickness of approximately 0.1 mm to 1.5 mm, in particular of 0.25 mm to 1.0 mm.

A simple production of the power electronics unit may be achieved by applying a system of conductor tracks and/or insulating layers and/or resistors to the ceramic substrate using thick-film technology. More specifically, thick-film hybrid technology may be used to apply the system of conductor tracks and/or insulating layers and/or resistors. The electronic components may be soldered onto the system of conductor tracks in a reflow or vapor phase process.

The system of conductor tracks may alternatively be applied to the ceramic substrate by thin-film technology or as a copper coating.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The single FIGURE of this application is a cross-sectional view of an electronics unit according to an embodiment of the present invention.

### DETAILED DESCRIPTION OF THE PRESENTLY PREFERRED EMBODIMENTS

The electronics unit shown in the FIGURE has a support 1 in the form of a plate of aluminium or an aluminum alloy which is provided on its one side with cooling ribs 2. On the planar surface opposite from the cooling ribs 2, a film 3 of an aluminum-silicon alloy (AlSi film) with a thickness of 20 μm is applied in a thermal process under an inert gas atmosphere and chemically bonded to the support 1.

The surface of the ceramic substrate 4 facing away from the support 1 has conductor tracks 5, 5′, 5″ and 5′″, applied by thick-film technology. The conductor tracks 5, 5′, 5″ and 5′″ may, for example, comprise a copper coating. In this case, a thick-film resistor 6 is also applied to the conductor tracks 5′″, also by thick-film technology such as, for example, thick-film hybrid technology.

An electronic component 7 is soldered onto the conductor tracks 5″.

An electronic power component 8 is soldered onto the conductor track 5′ and is connected to the conductor track 5 by a bonding wire 9.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An electronics unit, comprising:
a support in the form of a plate of one of aluminum and an aluminum alloy;
a ceramic substrate adhesively attached to said support, said ceramic substrate having a system of conductor tracks and electronic power components arranged on said system of conductor tracks; and
a film of an aluminum-silicon alloy arranged between said support and said ceramic substrate, said film being chemically bonded to said support and said ceramic substrate in a thermal process.

2. The electronics unit of claim 1, wherein said film has a thickness in the range of approximately 5 μm to 70 μm.

3. The electronics unit of claim 1, wherein a thickness of said support corresponds to a multiple of a thickness of said ceramic substrate.

4. The electronics unit of claim 3, wherein the thickness of said support is approximately ten times the thickness of said ceramic substrate.

5. The electronics unit of claim 1, wherein said support includes cooling ribs on a side of said support facing away from said ceramic substrate.

6. The electronics unit of claim 1, wherein said ceramic substrate has a thickness in the range of approximately 0.1 mm to 1.5 mm

7. The electronics unit of claim 1, wherein said system of conductor tracks is applied to said ceramic substrate by thick-film hybrid technology.

8. The electronics unit of claim 7, wherein said electronic components are soldered onto said system of conductor tracks in a reflow or vapor phase process.

9. The electronics unit of claim 1, wherein said system of conductor tracks is applied to said ceramic substrate by thin-film technology.

10. The electronics unit of claim 1, wherein said system of conductor tracks is applied to said ceramic substrate as a copper coating.

11. The electronics unit of claim 1, wherein said film has a thickness in the range of approximately 10 μm and 50 μm.

12. The electronics unit of claim 1, wherein said ceramic substrate has a thickness in the range of approximately 0.25 mm to 1.0 mm.

13. The electronics unit of claim 1, further comprising at least one of insulating layers and resistors, said system of conductor tracks and said at least one of insulating layers and resistors is applied to said ceramic substrate by thick-film hybrid technology.

14. The electronics unit of claim 1, wherein said ceramic substrate is adhesively attached to said support by said film.
